(19) United States
(12) Patent Application Publication
(10) Pub. No.: US 2014/0278967 A1
(43) Pub. Date: Sep. 18, 2014

(54) DETERMINING TARGET CUSTOMERS DURING MARKETING

(71) Applicant: HEWLETT-PACKARD DEVELOPMENT COMPANY, L.P., (US)

(72) Inventors: Biswajit Pal, Bangalore (IN); Subhasish Misra, Singapore (SG); Abhisek Saha, Williamantic, CT (US)

(73) Assignee: HEWLETT-PACKARD DEVELOPMENT COMPANY, L.P., Houston, TX (US)

(21) Appl. No.: 13/801,712

(22) Filed: Mar. 13, 2013

(51) Int. Cl. G06Q 30/02

(52) U.S. Cl. CPC G06Q 30/0254
USPC 705/14.52

(57) ABSTRACT

A method of determining which customers to target during marketing is disclosed. Parameters are estimated from inputs of sample customers from statistical procedures, and an approximation model is created for each of the estimated parameters. The approximation models are applied to transaction data collect for customers on a customer list. For each customer, the transaction data is applied to the approximation models to determine a dropout probability and a transaction rate. A likelihood of repeat purchase is determined for each customer based on the dropout probability and the transaction rate.

### BACKGROUND

Many firms collect information regarding their customers. Information can include customer basics such as a list of products or service purchased and the timing of the purchases to more sophisticated information such as demographics and psychographics. Firms use this information for a number of reasons including hindsight, but one such reason is to help project future sales. A typical projection can include aggregate sales trajectories, such as a forecast of sales in the next time period, e.g., 52 weeks. Sales trajectories can help the firm hire the appropriate people, purchase a proper amount of inventory, and make other business decisions in anticipation of future demand. The collected information can be also used for other projections such as individual-level conditional expectations. Sophisticated statisticians apply the collected information to create models in order to hazard a guess as to the likelihood and timing of a particular customer's future purchases.

### BRIEF DESCRIPTION OF THE DRAWINGS

FIG. 1 is a flow diagram illustrating a scalable system of determining the likelihood a customer will make a repeat purchases during a selected future time period.

FIG. 2 is flow diagram illustrating a process to a score a customer database with the system of FIG. 1.

FIG. 3 is a schematic diagram illustrating an example computing device for performing features of the process of FIG. 2.

FIG. 4 is a schematic diagram illustrating an example cloud system for performing the process of FIG. 2.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Marketing strategy is a process that can allow a firm to concentrate its resources on the optimal opportunities with the goals of increasing sales and achieving a sustainable competitive advantage. Marketing strategy includes activities in the field of marketing related to analysis of a strategic initial situation of a firm and also a formulation, evaluation, and selection of market-oriented strategies to contribute to the goals of the firm and its marketing objectives. A target market is a group of customers towards which the firm has decided to market its products or services. In the context of targeted marketing to consumers, the ability to tell which customers are more likely than others to make a purchase in the near future can greatly enhance effectiveness of any marketing campaign. It can be used to provide preferential treatment of the customers determined ready to purchase and also reduce the likelihood of bombarding customers who are less likely to purchase with marketing materials that could possibly alienate them from the brand or firm.

FIG. 1 illustrates an example system 100 configured to determine target customer based on the likelihood they will make a future purchase in future period of time. The system 100 includes access to a firm's customer information 102. In one example, the customer information can be stored in a database such as a customer relationship management (CRM) database. CRM databases can include information on a few customers to over one hundred million customers with detailed records for each customer. Many CRM tools are subscription based web applications or software as a service (SaaS), and system 100 can be configured to access the relevant information or records used to determine the target customers. The relevant information is provided to a scoring engine 104, which receives a set of information for each customer and determines a probability of a future purchase for each customer based on that set of information. Examples of the scoring engine 104 are described below. The customers can be scored or ranked by their associated probability of future purchase to provide an output at 106. In one example, the entire customer list is ranked from most likely to purchase to least likely to purchase. In other examples, the scoring engine can be configured to provide only a list of customers that meet a selected threshold such as those customers that are above a selected probability, a selected number of customers, or a selected percentage of the customers ranked. The marketing group, which may be part of the firm or associated with the firm, can apply the list to effectively and efficiently target market.

Many firms are reluctant to make projections on future sales because they believe, and intuition suggests, that such projections can only be made with a vast amount of information about a customer using highly sophisticated statistical models beyond their comprehension operating on expensive computing power. An example of one statistical model used to determine the probability that a customer will make a purchase during a given the future time period is provided below.

The probability of customer j making a purchase in the next k time period is based on the likelihood the customer remains and active customer multiplied by the likelihood an active customer will make a purchase during time period k. A mathematical expression for this is given by

(1−pⱼ)(1−exp{—kλⱼ})

The parameter p is the likelihood that customer j has become inactive, or dropout probability, and will not make a purchase in the future. Examples on why a customer has become inactive can include the customer has switched brands or firms for purchases and the customer has passed away, as well as many other examples. If the parameter pⱼ represents the probability that customer j has become inactive, then the first part of the expression, i.e., (1−pⱼ), represents the likelihood that the customer j remains an active customer.

The expression (exp{−kλⱼ}) represents the likelihood that an active customer j will not make a purchase during a time period k. In one example, k can be defined as the time period between the customer's last purchase and a selected time in the future. In another example, k can be defined as the time period from now until the selected time in the future. The parameter λ is the transaction rate for the customer. If the expression (exp{−kλⱼ}) represents the likelihood that an active customer j will not make a purchase during a time period k, then the expression (1−exp{−kλⱼ}) represents the likelihood that an active customer j will make a purchase during time period k. While the mathematical expression itself is relatively straightforward and not intensive, the determination of the parameters of transaction rate λ and the dropout probability p for each customer is based on expensive computation of relevant information for each customer that can be stored as part of customer information 102.

The mathematical expression is based on BG/NDB (beta-gamma/negative binomial distribution model). This model makes several assumptions. Among these assumptions include the following three assumptions:

1. While active, the number of transactions made by a customer follows a Poisson process with transaction rate A. This is equivalent to assuming that the time between transactions is distributed exponentially with transaction rate λ.

2. After any transaction, a customer becomes inactive with probability p. Therefore the point at which the customer “drops out” is distributed across transactions according to a (shifted) geometric distribution.

3. The transaction rate λ and the dropout probability p vary independently across customers.

The parameters of transaction rate λ and the dropout probability p were estimated for each customer using a Bayesian Hierarchical model. Bayesian analysis is a statistical procedure that attempts to estimate parameters of an underlying distribution based on the observed distribution. Bayesian analysis can begin with a prior distribution that may be based on an assessment of the relative likelihoods of parameters or the results of non-Bayesian observations. A prior distribution of an unknown quantity, which may be a parameter or latent variable, is the probability distribution that would express an uncertainty about the unknown quantity before evidence is taken into account. A posterior distribution is the probability distribution of the unknown quantity, treated as a random variable, and is conditional on the evidence obtained from an experiment or survey. The posterior distribution is determined from a likelihood function that is a set of parameter values given some observed outcomes equal to the probability of those observed outcomes given those parameter values. The prior distribution is multiplied by the likelihood function and normalized to obtain a posterior distribution. The mode of the posterior distribution is the parameter estimate.

A Markov chain Monte Carlo (MCMC) algorithm was employed to sample from the posterior distribution of the parameters. MCMC methods can be applied Bayesian Hierarchical models and allow a wide range of posterior distributions to be simulated and their parameters found numerically. MCMC methods are a class of algorithms for sampling from probability distributions based on constructing a Markov chain that has the desired distribution as its equilibrium distribution. The state of the chain after a large number of steps is then used as a sample of the desired distribution. The quality of the sample improves as a function of the number of steps or iterations.

The data used for sampling the posterior distributions in the MCMC for a customer in this statistical model is relatively modest and can be readily obtained from basic records of a customer database, such as list 102. The data used for sampling the posterior distributions in the MCMC includes first transaction date t₁, last transaction date tₓ, and the number of transactions x, which were used as exemplary, or independent, variables. The exemplary variables are readily obtained from the transaction history of customers. Accordingly, no demographic, psychographic variables were used in this model. The medians of the posterior distributions, sampled by the MCMC algorithm, were used as estimates of λⱼ and pⱼ for each customer j. After hundreds of iterations of the MCMC algorithm for each customer, the Bayesian Hierarchal model described above is effective at determining the likelihood of the customer to make a purchase during the time period k.

The computational complexity of the Bayesian Hierarchal model means that even though the results are promising, they are not ready to be operationalized. Difficulty lies with the scalability of the Bayesian Hierarchal model. The computational resources to provide hundreds of iterations of the MCMC algorithm to determine the parameters of transaction rate λ and the dropout probability p for each customer may be available for small customer lists, but many firms have databases with transaction data for millions of customers. Accordingly, the Bayesian Hierarchal model and MCMC algorithm are not scalable to effectively score large customer lists.

Alternatives to the Bayesian Hierarchal model and MCM algorithm have been developed. Logistic regression has been used to model events such as purchase or no purchase in a given time period such as one year. Logistic regression suffers from the disadvantage of not being efficient for variable time periods. For each new time period k, a new logistic regression model is built and validated. Recency-frequency-monetary (RFM) analytics have also been used to segment customers according to their transaction history by rating loyalty value. RFM is relatively crude and does not provide modeling assumption or much predictive value in determining the likelihood of customer repeating a purchase in a given time period.

FIG. 2 illustrates a method 200 for use with scoring engine 104 to efficiently and accurately score customer lists of any size and is scalable to meet the features of big data. Method 200 applies a Bayesian Hierarchal model and MCMC algorithm to estimate parameters for a set of exemplary variable for each sample customer in a sample customer list at 202. Approximation models are constructed for the estimated parameters at 204. The approximation models are deployed at 206. The approximation model is applied to exemplary variables for customers in customer lists at 208, and the customer lists can be of various sizes and time periods. The approximation model is applied to the customer list to generate a scored list at 210.

A Bayesian Hierarchal model and MCMC algorithm are developed and applied to a sample customer list at 202, such as the model and algorithms set forth above. The model and algorithm receive inputs from the example customer list and determine parameters for each customer based on the received inputs. In one example the inputs described above, i.e., first transaction date t₁, last transaction date tₓ, and the number of transactions x, are used to determine the parameters of transaction rate λ and the dropout probability p for each customer.

Approximation models are constructed for the estimates of the parameters at 204. In one example, two approximation models are constructed, such as one for estimates for the transaction rate λ and one for estimates of the dropout probability p. The estimates can be determined for the inputs of first transaction date t₁, last transaction date tₓ, and the number of transactions x for convenience. Another consideration includes a feature where the inputs of one customer will result in the same parameters as the same inputs for another customer. Further, approximation models can better estimate the parameters if the Bayesian Hierarchal model and MCMC algorithm is applied to a greater number of sample customers and a greater number of iterations. In one example, the Bayesian Hierarchal model and MCMC algorithm is applied to a sample customer list of about three-million customers. In one example, a sufficiently parameterized approximation model will capture patterns including non-linear effects and interactions.

A number of different approximation models can be used, and one example approximation model includes polynomial regression. Polynomial regression is a form of linear regression in which the relationship between the exemplary variable “x” and the dependent variable “y” is modeled as an nth order polynomial. Polynomial regression fits a nonlinear relationship between the value of “x” and the corresponding conditional mean of “y,” denoted E(y|x), and can be used to describe nonlinear phenomena. Although polynomial regression fits a nonlinear model to the data, as a statistical estimation problem it is linear, in the sense that the regression function E(y|x) is linear in the unknown parameters that are estimated from the data. For this reason, polynomial regression is considered to be a special case of multiple linear regression.

In an example of constructing an approximation model at 204, a polynomial regression fit is applied for each of the parameters of transaction rate λⱼ and dropout probability pⱼ as estimated for each customer j in the sample customer list of three-million customers through the Bayesian Hierarchal model and MCMC. Logarithms of the response are used for the parameter estimates of transaction rate λ and the dropout probability p with predictors first transaction date t₁, last transaction date tₓ, and the number of transactions x. In some examples, other interaction variables can be used as predictors. In one example, the degree of polynomial fit is explored with a non-parametric fit from a Generalized Additive Model, or GAM. The response in a GAM is modeled as a sum of spline functions of the individual predictors. While the GAM also provides an example approximation model, the polynomial regression fit has been determine to be faster at determining parameters during operation, and thus provides benefits for scoring large customer lists.

Once the approximation model is deployed at 206, such as a service to owners of customer lists, any number of customer lists of various sizes and interested time periods can be applied at 208 and readily scored at 210. In one example, the Bayesian Hierarchal model and MCMC algorithm used to estimate parameters for a set of exemplary variable for each customer in an example customer list at 202 and the construction of approximation models are for the estimated parameters at 204 are performed in a separate from performing the approximation model as a service, such as in separate modules. In one example, the features of 202 and 204 are performed in a module off-line and prior to deploying the approximation model at 206. In another example, the features of 202 and 204 are performed in a module simultaneously with the deployed approximation model such as to update the currently used approximation model. In a typical example, the computing resources to perform features 202 and 204 can be much more complex and extensive than the computing resources used to score the customers. the features of 202 and 204 can be performed on separate computing resources than features 206 and 208.

The customer lists can be mined for the exemplary variables of each customer, the owner of the customer lists can isolate and provide the records for the exemplary variables, or some combination of two can be used to provide the exemplary variables to the approximation models for the parameters of transaction rate λ and dropout probability p. Once determined from the approximation models, the parameters for each customer j can be input into

(1−pⱼ)(1−exp{−kλⱼ})

to obtain the probability of each customer making at least a purchase in the next k time period. The service can provide additional analytical information such as arranging the customer list in order of score or extracting a subset of customers meeting some predetermined threshold such as customers above a certain probability rate.

To validate the utility of process 200, hypotheses were formulate about the power of predicting repeat customers, the speed with which process 200 can be executed in big databases, and the ability to provide a solution for multiple marketing problems across various domains. Two hypotheses considered were: (1) whether the model performs better than random targeting, and (2) whether the process is so fast that it can be applied on large data bases. The approximation model was determined using a sample customer list of three-million customers and polynomial regression was applied for each of the parameters. Random targeting of a given percentage of customers can be expected to result in the given percentage of repeat buyers. For example, if 40% of customers are targeted one can expect to reach about 40% of the repeat purchasers. Process 200 outperformed random targeting for every percentage of customers targeted from at least 10% to almost 100%. The results also demonstrated that targeting at least 40% of the customers captures over 75% of the repeat buyers.

Process 200 is also more efficient than the over the Bayesian Hierarchal model and MCMC algorithm. The deployed approximation model was demonstrated to be about 180 times faster over the Bayesian Hierarchal model and MCMC algorithm. For example, a list of one-million customers was scored in approximately 30 hours with the Bayesian Hierarchal model and MCMC algorithm. The same list of one-million customers was scored in approximately 10 minutes using the deployed approximation model.

Process 200 also provided a very satisfactory result when back-tested on data from a back-to-school marketing campaign. The customers that scored in the top 10% of the list based on the results from a deployed model contributed 37% of the total revenue in the marketing campaign. Accordingly, the results indicate the process 200 can be used for customer selection to identify the more valuable customers. Process 200 also can help reduce the cost of a campaign and the percentage of incorrect targeting which may lead to a bad customer experience.

FIG. 3 illustrates an exemplary computer system that can be employed in an operating environment and used to host or run a computer application included on one or more computer readable storage mediums storing computer executable instructions for controlling the computer system, such as a computing device, to perform a process to efficiently and accurately score customer lists of any size and is scalable to meet the features of big data such as process 200. The computer system can also be used to develop an approximation model for deployment or to apply customer lists to the deployed approximation model. In some examples, the customer lists can also be stored on computer readable storage mediums.

The exemplary computer system includes a computing device, such as computing device 300. In a basic hardware configuration, computing device 300 typically includes a processor system 302 having one or more processing units, i.e., processors 304, and memory 306. By way of example, the processing units may include, but are not limited to, two or more processing cores on a chip or two or more processor chips. In some examples, the computing device can also have one or more additional processing or specialized processors (not shown), such as a graphics processor for general-purpose computing on graphics processor units, to perform processing functions offloaded from the processor 304. The memory 306 may be arranged in a hierarchy and may include one or more levels of cache. Depending on the configuration and type of computing device, memory 306 may be volatile (such as random access memory (RAM)), non-volatile (such as read only memory (ROM), flash memory, etc.), or some combination of the two. The computing device 300 can take one or more of several forms. Such forms include a tablet, a personal computer, a workstation, a server, a handheld device, a consumer electronic device (such as a video game console), or other, and can be a stand-alone device or configured as part of a computer network, computer cluster, cloud services infrastructure, or other.

Computing device 300 can also have additional features or functionality. For example, computing device 300 may also include additional storage. Such storage may be removable and/or non-removable and can include, but is not limited to, magnetic or optical disks or solid-state memory, or flash storage devices such as removable storage 308 and non-removable storage 310. Computer storage media includes volatile and nonvolatile, removable and non-removable media implemented in any suitable method or technology for storage of information such as computer readable instructions, data structures, program modules or other data. Memory 306, removable storage 308 and non-removable storage 310 are all examples of computer storage media. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or any other storage medium that can be used to store the desired information and that can be accessed by computing device 300. Any such computer storage media may be part of computing device 300.

Computing device 300 often includes one or more input and/or output connections, such as USB connections, display ports, proprietary connections, and others to connect to various devices to provide inputs and outputs to the computing device. Input devices 312 may include devices such as keyboard, pointing device (e.g., mouse), pen, voice input device, touch input device, or other. Output devices 314 may include devices such as a display, speakers, printer, or the like.

Computing device 300 often includes one or more communication connections 316 that allow computing device 300 to communicate with other computers/applications 318. Example communication connections can include, but are not limited to, an Ethernet interface, a wireless interface, a bus interface, a storage area network interface, and a proprietary interface. The communication connections can be used to couple the computing device 300 to a computer network, which can be classified according to a wide variety of characteristics such as topology, connection method, and scale. A network is a collection of computing devices and possibly other devices interconnected by communications channels that facilitate communications and allows sharing of resources and information among interconnected devices. Examples of computer networks include a local area network, a wide area network, the Internet, or other network.

Computing device 300 can be configured to run an operating system software program and one or more computer applications, which make up a system platform. A computer application configured to execute on the computing device 300 includes at least one process (or task), which is an executing program. Each process provides the resources to execute the program. One or more threads run in the context of the process. A thread is the basic unit to which an operating system allocates time in the processor 304. The thread is the entity within a process that can be scheduled for execution. Threads of a process can share its virtual address space and system resources. Each thread can include exception handlers, a scheduling priority, thread local storage, a thread identifier, and a thread context, or thread state, until the thread is scheduled. A thread context includes the thread's set of machine registers, the kernel stack, a thread environmental block, and a user stack in the address space of the process corresponding with the thread. Threads can communicate with each other during processing through techniques such as message passing.

FIG. 4 is a schematic diagram illustrating an example cloud computing system 400 that can be used to make available the deployed approximation model to owners of customer lists as a service. In another example, a cloud computing system can be used to develop the approximation model. Typically, the cloud computing system 400 includes a front end 402, often referred to as an on-premises client, and a back end 404, often referred to as the cloud. The front end 402 and the back end 404 are coupled together through a network 406, such as the Internet. The front end 402 includes client devices 408 that can be constructed in accordance with computing device 300 in one example. Each of the client devices 408 includes an application (not shown) running on the client device 408 to permit access the cloud computing system 400. In one example, the application can be a general-purpose web browser, or the application can be a particular application having availability limited to clients of a particular cloud system. The back end 404 includes computing devices including servers and data storage systems coupled together to create the cloud portion of computing services.

In one example, a cloud architecture 410 includes an infrastructure 412, an application platform 414 (sometimes referred to as Platform as a Service or PaaS), storage 416, and applications 418 that permits the client to access systems and information without having to purchase or maintain the underlying software and hardware used to perform the services of the back end 404. Most cloud computing infrastructures consist of services delivered through common centers and built on servers. The application platform 414 allows applications to be hosted and run at one or more typically remote datacenters. In one example, the datacenters can themselves include forms of distributed computing such as computing clusters and storage. The application platform 414 can also provide a cloud operating system that serves as a runtime for the applications and provides a set of services that allows development, management and hosting of applications off-premises. Services and applications 418 built using the platform 414 or for the platform 414 can run on top of the operating system. Generally, the operating system can include three components including compute, storage, and host. Compute provides a computation environment, and storage provides scalable storage, such as tables, queue, and so on, for large scale needs. The host environment can pool individual systems into a network for managing resources, load balancing, other services for the applications, and the like without using the hosted applications 418 to explicitly perform those functions.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

I/We claim:

1. A method of determining customers to target during marketing, comprising:
estimating parameters from inputs of sample customers and providing an approximation model for each of the estimated parameters;
receiving transactional data collected for a plurality of customers from a customer list;
for each customer from the customer list:
determining corresponding explanatory variables from the transaction data;
applying the explanatory variables to the approximation models to determine a dropout probability (p) and a transaction rate (λ); and
determining a likelihood of a repeat purchase during a selected time period based on the dropout probability (p) and a transaction rate (λ); and
scoring the customers from the customer list based on the likelihood of repeat purchase.

2. The method of claim 1 comprising targeting customers from the customer list determined to have a likelihood of repeating that is higher than a selected threshold amount.

3. The method of claim 1 wherein estimating parameters includes applying a Bayesian Hierarchal model and a Markov chain Monte Carlo algorithm to the inputs of the plurality of sample customers.

4. The method of claim 3 wherein the approximation model includes polynomial regression.

5. The method of claim 1 wherein the exemplary variables include a timing of a first purchase, a timing of a last purchase, and a number of purchases from the first purchase to the last purchase.

6. The method of claim 5 wherein inputs used to estimate the parameters include the exemplary variables.

7. The method of claim 5 wherein interaction variables are applied to the approximation models.

8. The method of claim 1 wherein determining the likelihood of a repeat purchase during the selected time period based on a product of:
a likelihood the customer will remain a customer as determined from the dropout probability (p), and
a likelihood the customer will make a purchase during the selected time period as determined from the transaction rate (λ).

9. The method of claim 8 where determining the likelihood of a repeat purchase during the selected time period k for each customer j in the customer list is based on:
(1−pⱼ)(1−exp{−kλⱼ}).

10. The method of claim 1 wherein the approximation model is applied to a plurality of different customer lists and to a plurality of different time periods.

11. A system for determining customers to target during marketing, comprising:
a first module configured to estimate parameters of dropout probability and transaction rate from inputs of sample customers and provide an approximation model for the dropout probability and an approximation model for transaction rate; and
a second module configured to receive transactional data collected for a plurality of customers from a customer list and configured to apply the transactional data to determine a likelihood of a repeat purchase during a selected time period based on the dropout probability and a transaction rate from the approximation models.

12. The system of claim 11 wherein the second module is configured to receive a plurality of different customer lists and a plurality of different time periods to be applied to the approximation models.

13. The system of claim 11 wherein the second module provides a scored customer list.

14. The system of claim 11 wherein the first module estimate parameters of dropout probability and transaction rate from inputs of sample customers based on a Bayesian Hierarchal model and a Markov chain Monte Carlo algorithm.

15. The system of claim 14 wherein the second module generates the approximation models from a polynomial regression of estimates of the parameters.

16. The system of claim 11 wherein the transactional data applied to the approximation model in the second module includes a timing of a first purchase, a timing of a last purchase, and a number of purchases from the first purchase to the last purchase for each customer on the customer list.

17. The system of claim 11 wherein the first and second modules are included as part of cloud computing system.

18. The system of claim 11 wherein the first module estimates parameters of dropout probability and transaction rate simultaneously with the second module applying the transactional data to determine a likelihood of a repeat purchase during a selected time period based on the dropout probability and a transaction rate from the approximation models.

19. A computer readable storage medium storing computer executable instructions for controlling a computing device to perform a process for determining customers to target during marketing, the process comprising:
estimating parameters of dropout probability and transaction rate from inputs of sample customers;
providing an approximation model for the dropout probability and an approximation model for transaction rate;
receiving transactional data collected for a plurality of customers from a customer list; and
applying the transactional data to determine a likelihood of a repeat purchase during a selected time period based on the dropout probability and a transaction rate from the approximation models.

20. The computer readable storage medium of claim 19 wherein applying the transactional data includes, for each customer from the customer list,
determining corresponding explanatory variables from the transaction data, the explanatory variables including,
a timing of a first purchase,
a timing of a last purchase, and
a number of purchases from the first purchase to the last purchase;
using the explanatory variables to determine a dropout probability transaction rate from the approximation models; and
determining a likelihood of a repeat purchase during a selected time period from a product of,
a likelihood the customer will remain a customer as determined from the dropout probability, and
a likelihood the customer will make a purchase during a further period of time as determined from the transaction rate.
